(19) United States
(12) Patent Application Publication
(10) Pub. No.: US 2025/0117950 A1
(43) Pub. Date: Apr. 10, 2025

(54) Apparatus And Method For Object Tracking And Apparatus And Method For Controlling A Vehicle Using The Same

(71) Applicants: Hyundai Motor Company, Seoul (KR); Kia Corporation, Seoul (KR)

(72) Inventor: Nam Hyung Lee, Seoul (KR)

(21) Appl. No.: 18/734,168

(22) Filed: Jun. 5, 2024

(30) Foreign Application Priority Data
Oct. 6, 2023 (KR) 10-2023-0133515

(51) Int. Cl. G06T 7/20; G06T 7/13; G06T 7/70; G06V 20/56

(52) U.S. Cl. CPC G06T 7/20; G06T 7/13; G06T 7/70; G06V 20/56; G06V 2201/07

(57) ABSTRACT

The present disclosure relates to an apparatus for tracking an object, a method thereof, an apparatus for controlling a vehicle by using the same, and a method thereof. The apparatus may comprise a camera configured to obtain image data, a sensor configured to obtain a set of points, and a processor. The processor is configured to detect an object outside a vehicle, determine a track as a partial track based on a determination that the track is within a threshold distance from a reference track generated based on the image data, wherein the track is generated based on information obtained by the sensor, determine an object track including the partial track, and generate, by fusing the object track and the reference track, a final track indicating a location of the object, and output a signal indicating the final track.

### CROSS-REFERENCE TO RELATED APPLICATION

This application claims the benefit of priority to Korean Patent Application No. 10-2023-0133515, filed in the Korean Intellectual Property Office on Oct. 6, 2023, the entire contents of which are incorporated herein by reference.

### TECHNICAL FIELD

The present disclosure relates to an apparatus for tracking an object, a method thereof, and an apparatus for controlling a vehicle by using the same, and more specifically, relates to a technology for tracking an object by using a sensor fusion method.

### BACKGROUND

An autonomous vehicle refers to a vehicle capable of driving on its own without intervention of a driver or a passenger. An autonomous driving system refers to a system that monitors and controls the autonomous vehicle such that the autonomous vehicle is capable of driving on its own. The autonomous vehicle, in a broad sense, may refer to a vehicle that monitors the outside of the vehicle to assist a driver in driving and is equipped with various driving assistance devices based on the monitored external environment of the vehicle.

The autonomous vehicle or a vehicle equipped with a driving assistance device may detect an object by monitoring the outside of the vehicle, and drive based on a scenario determined depending on the detected object. In other words, the autonomous driving or driving according to driving assistance devices may use a process of determining the type of an object outside the vehicle.

Sensors for monitoring the outside of the vehicle may include cameras, Radio Detection and Ranging (RADAR), Light Imaging Detection and Ranging (LIDAR), and the like. A method of detecting or tracking an object may be used by fusing sensing results of two or more sensors to increase or maximize each advantage.

If the density of a point cloud obtained by the LIDAR in a process of fusing information obtained by the LIDAR through sensor fusion is unsatisfactory, the point cloud corresponding to the object may not be reflected properly. In particular, because the density of a point cloud obtained by the LIDAR is reduced if the object is far away or the reflectance of the object is not satisfactory, the point cloud for an object may be missing.

As such, the location of an object may not be accurately determined due to missing LIDAR information. The reliability of driving according to the autonomous driving or the driving according to the driving assistance devices may be reduced because the exact location of the object is not determined or determined inaccurately.

### SUMMARY

According to the present disclosure, an apparatus comprising a camera configured to obtain image data, a sensor configured to obtain a set of points, and a processor, wherein the processor is configured to detect an object outside a vehicle, determine a track as a partial track based on a determination that the track is within a threshold distance from a reference track generated based on the image data, wherein the track is generated based on information obtained by the sensor, determine an object track including the partial track, and generate, by fusing the object track and the reference track, a final track indicating a location of the object, and output a signal indicating the final track.

The apparatus, wherein the reference track is obtained by expressing the object in a top-view in a coordinate system, wherein the object is detected from the image data.

The apparatus, wherein the track is expressed in a top-view in a coordinate system based on a cluster state of the set of points.

The apparatus, wherein the processor is configured to determine a first reference line indicating a side surface of the object, wherein the object is in the reference track, and determine whether the shortest distance between the first reference line and a center point of the track is within the threshold distance.

The apparatus, wherein the processor is configured to determine, as the first reference line, a line segment indicating a side surface, which is closer to the vehicle, chosen from among a plurality of side surfaces of the object.

The apparatus, wherein the processor is configured to determine, as the first reference line, a straight line connecting one end of a front bumper of the object and one end of a rear bumper of the object, and compare the shortest distance between the center point of the track and the first reference line with the threshold distance.

The apparatus, wherein the processor is configured to include the track in the object track based on a determination that the center point of the track is located between a second reference line indicating a front side of the object and a third reference line indicating a rear side of the object.

The apparatus, wherein the processor is configured to increase the threshold distance as reflectance of the object decreases.

The apparatus, wherein the processor is configured to increase the threshold distance as a weather state in an area comprising the vehicle deteriorates.

The apparatus, wherein the processor is configured to control the vehicle based on the signal indicating the final track.

According to the present disclosure, a method may comprise generating a reference track indicating a location of an object detected by using a sensor other than a light imaging detection and ranging (LIDAR) sensor, determining a track as a partial track based on a determination that the track is within a threshold distance from the reference track, wherein the track is generated based on information obtained by the LIDAR sensor, and determining an object track including the partial track, generating, by fusing the object track and the reference track, final track indicating the location of the object, and outputting a signal indicating the final track.

The generating of the reference track may comprise expressing the object in a top-view in a coordinate system, wherein the object is detected from image data.

The determining of the track as the partial track may comprise expressing the track, which is determined based on a cluster state of a set of points obtained by the LIDAR sensor, in a top-view in a coordinate system.

The determining of the track as the partial track may comprise determining a first reference line indicating a side surface of the object, wherein the object is in the reference track, and determining whether the shortest distance between the first reference line and a center point of the track is within the threshold distance.

The determining of the first reference line may comprise determining, as the first reference line, a line segment indicating a side surface, which is closer to a vehicle, chosen from among a plurality of side surfaces of the object.

The determining of the track as the partial track may comprise comparing the shortest distance between the center point of the track and the first reference line with the threshold distance.

The determining of the track as the partial track may comprise obtaining a second reference line indicating a front side of the object based on the shortest distance between the center point of the track and the first reference line being within the threshold distance, obtaining a third reference line indicating a rear side of the object, and including the track in the object track based on the center point of the track being located between the second reference line and the third reference line.

The method may further comprise increasing the threshold distance as reflectance of the object decreases.

The method may further comprise increasing the threshold distance as a weather state in an area comprising a vehicle deteriorates.

The method may further comprise controlling a vehicle based on the signal indicating the final track, wherein the location of the object is outside the vehicle.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a configuration of an object tracking apparatus and a vehicle control apparatus including the same, according to an example of the present disclosure;

FIG. 2 shows an example of a vehicle equipped with a sensor device of an object tracking apparatus, according to an example of the present disclosure;

FIG. 3 shows an example of an operation of a processor;

FIG. 4 shows an example of an object tracking method, according to an example of the present disclosure;

FIG. 5 shows an example of an image expressed by image data obtained by a camera;

FIG. 6 shows an example of a reference track generated by a processor;

FIG. 7 and FIG. 8 show examples of a method of determining whether a LIDAR track is included in a first area;

FIG. 9 shows an example of a method of determining whether a LIDAR track belongs to a second area;

FIG. 10 shows an example of LIDAR tracks located within a reference track and a threshold distance;

FIG. 11 shows an example of a final track according to a comparative example;

FIG. 12 shows an example of a final track, according to an example of the present disclosure; and

FIG. 13 shows an example of a computing system according to an example of the present disclosure.

### DETAILED DESCRIPTION

Hereinafter, some examples of the present disclosure will be described in detail with reference to the accompanying drawings. In adding reference numerals to components of each drawing, it should be noted that the same components have the same reference numerals, although they are indicated on another drawing. Furthermore, in describing the examples of the present disclosure, detailed descriptions associated with well-known functions or configurations will be omitted if they may make subject matters of the present disclosure unnecessarily obscure.

In describing elements of an example of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. It will be understood that terms used herein should be interpreted as having a meaning that is consistent with their meaning in the context of the present disclosure and the relevant art and will not be interpreted in an idealized or overly formal sense unless expressly so defined herein.

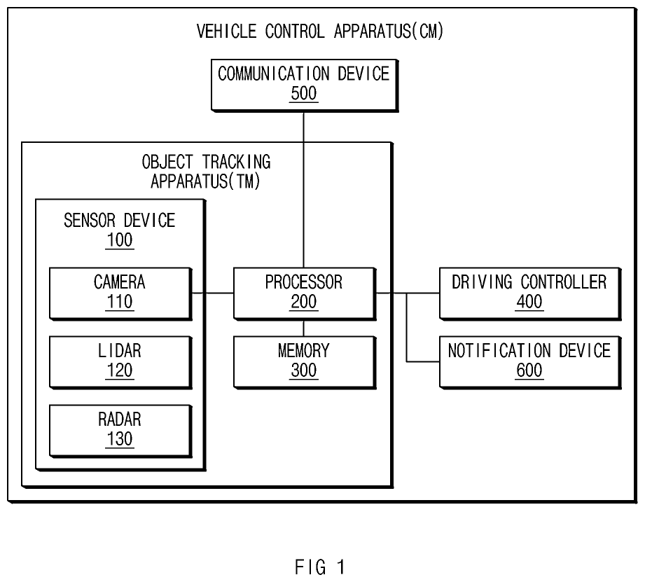

Hereinafter, various examples of the present disclosure will be described in detail with reference to FIGS. 1 to 13.

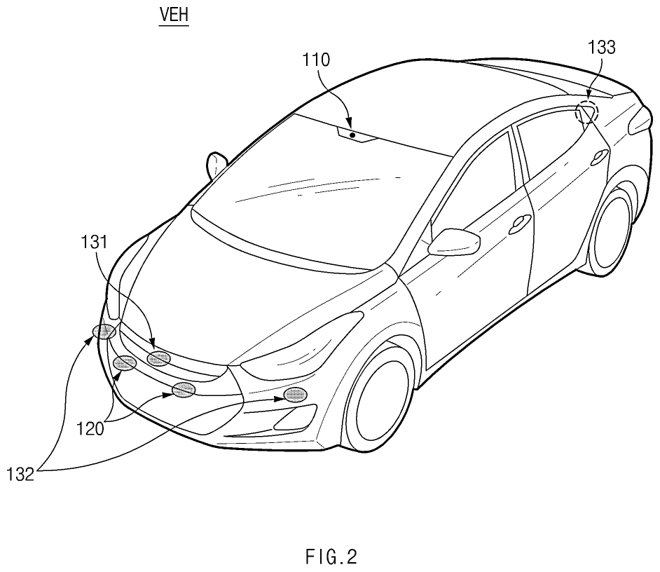

FIG. 1 shows an example of a configuration of an object tracking apparatus and a vehicle control apparatus including the same, according to an example of the present disclosure. FIG. 2 shows an example of a vehicle equipped with a sensor device of an object tracking apparatus, according to an example of the present disclosure.

Referring to FIGS. 1 and 2, a vehicle control apparatus according to an example of the present disclosure may include a sensor device 100, a processor 200, a memory 300, a driving controller 400, a communication device 500, and a notification device 600.

The sensor device 100 may include at least one of a camera 110, a LIDAR 120, or a RADAR 130 for detecting external objects of a vehicle VEH.

The camera 110 may be used to obtain an external image of the vehicle VEH, and may obtain a front image or anterolateral image of the vehicle VEH. For example, the camera 110 may be placed around a front windshield to obtain a front image of the vehicle VEH.

The LIDAR 120 may be used to determine an object by using reflected waves of a laser reflected from an object after the laser is emitted to the object, and may be implemented in a time of flight (TOF) method or a phase-shift method. The LIDAR 120 may be mounted to be exposed to the exterior of a vehicle and may be placed around a front bumper or front grill.

The RADAR 130 may include an electromagnetic wave transmission module and an electromagnetic wave reception module. The RADAR 130 may be implemented in a pulse radar method or a continuous wave radar method in view of the radio emission principle. The RADAR 130 may be implemented in a frequency modulated continuous wave (FMCW) method or a frequency shift keying (FSK) method among continuous wave radar methods depending on a signal waveform. The RADAR 130 may include a front RADAR 131 located at a front center of the vehicle VEH, an anterolateral RADAR 132 located at both ends of the front bumper, and a rear RADAR 133 located at the rear of the vehicle VEH.

Locations of the camera 110, the LIDAR 120, and the RADAR 130 may not be limited to the example shown in FIG. 2.

In addition or alternative to those shown in the drawings, the sensor device may include an ultrasonic sensor and an infrared sensor. The ultrasonic sensor may include an ultrasonic transmission module and an ultrasonic reception module. The ultrasonic sensor may detect an object based on ultrasonic waves and may detect a location of the detected object, a distance to the detected object, and a relative speed. The ultrasonic sensor may be positioned at an appropriate location outside the vehicle to detect an object located at the front of the vehicle, the rear of the vehicle, or the side of the vehicle. The infrared sensor may include an infrared transmission module and an infrared reception module. The infrared sensor may detect an object based on infrared light and may detect a location of the detected object, a distance to the detected object, and a relative speed. The infrared sensors may be positioned outside the vehicle to detect objects located at the front of the vehicle, the rear of the vehicle, or the side of the vehicle.

In addition or alternative, the sensor device 100 may further include a brake-pedal position sensor (BPS) and an accelerator position sensor (APS) that generate a speed control command for shifting a vehicle.

The BPS may output a BPS signal depending on the degree of depression of the brake pedal provided in the vehicle. For example, the BPS signal may output data having a range from 0 to 100 depending on the depression of the brake pedal. A value of 0 may indicate that the brake pedal is not depressed, and a value of 100 may indicate that the brake pedal is maximally depressed.

The APS may output an APS signal depending on the degree of depression of an accelerator pedal provided in the vehicle. For example, the APS signal may output data having a range from 0 to 100 depending on the depression of the accelerator pedal. A value of 0 may indicate that the accelerator pedal is not depressed, and a value of 100 may indicate that the accelerator pedal is maximally depressed.

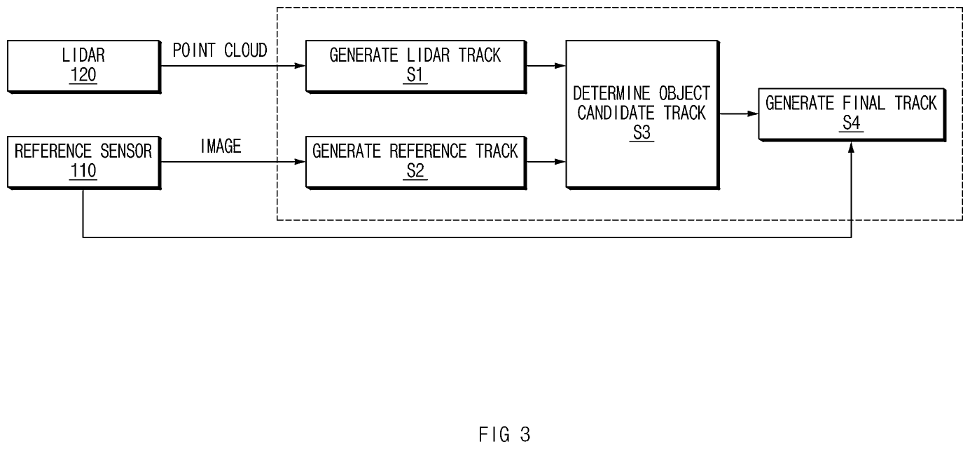

The processor 200 may track an object outside a vehicle and may perform evasive driving depending on a location of the object. The operation of the processor 200 is based on FIG. 3 as follows.

FIG. 3 shows an example of an operation of a processor.

Referring to FIG. 3, the processor 200 may generate a track (e.g., LIDAR track) based on a set of points (e.g., point clouds) obtained by a sensor (e.g., LIDAR 120 (S1)).

The LIDAR track may be generated based on a cluster state of point clouds. The LIDAR track may be obtained by representing the shape and location of an object by using a box on a plane parallel to a road surface in a coordinate system (e.g., a world or global coordinate system defining positions and orientations of objects or points in a three-dimensional space, for example, x, y, and z axes, or a higher-dimensional space). In other words, the LIDAR track may be expressed in a top-view in the world coordinate system. An example of FIG. 3 shows an example in which the processor 200 generates a LIDAR track. However, the LIDAR track may be generated by the LIDAR 120 or another processor.

Moreover, the processor 200 may generate a reference track RT based on image data obtained by the camera 110 (S2).

The reference track may be obtained by expressing the object detected from the image data in a top-view in the world coordinate system.

Furthermore, the processor 200 may determine an object track based on a location relationship between the reference track and the LIDAR track (S3).

The object track may include an object candidate track and a partial track.

The object candidate track may be determined based on an overlapping level between the object candidate track and the reference track, and a matching level of directions of the object candidate track and the reference track. In other words, the object candidate track may be determined based on the overlapping level of a specific level or more and point clouds having the clustering degree at which the point clouds are determined as one object.

The partial track may refer to a track capable of being estimated as an object track among fragmented LIDAR tracks. The partial track may be determined based on a location relationship with the reference track. According to an example, the processor 200 may determine a LIDAR track within a predetermined threshold distance from the reference track as a partial track (e.g., fragmented track).

According to an example of the present disclosure, the location of an object may be accurately determined because the object track is determined to include a partial track in addition or alternative to the object candidate track.

Besides, the processor 200 may generate a final track by fusing or merging the object track and the reference track (S4).

To perform at least one of procedures for generating the final track, the processor 200 may include an artificial intelligence (AI) processor. The AI processor may learn a neural network by using a pre-stored program. The neural network for detecting a target vehicle and a dangerous vehicle may be designed to simulate a human brain structure on a computer, and may include a plurality of network nodes, each of which has a weight and which simulate neurons of a human neural network. The plurality of network modes may exchange data depending on each connection relationship such that neurons simulate synaptic activity of neurons that signals exchange through synapses. The neural network may include a deep learning model developed from a neural network model. In the deep learning model, a plurality of network nodes may exchange data depending on a convolution connection relationship while being located on different layers. Examples of neural network models may include various deep learning techniques such as deep neural networks (DNN), convolutional deep neural networks (CNN), recurrent neural networks (RNN) restricted Boltzmann machine (RBM), deep belief networks (DBN), and deep Q-networks.

The memory 300 may store an algorithm for an operation of the processor 200 and an AI processor. The memory 300 may use a hard disk drive, a flash memory, an electrically erasable programmable read-only memory (EEPROM), a static random access memory (SRAM), a ferro-electric RAM (FRAM), a phase-change RAM (PRAM), or a magnetic RAM (MRAM), a dynamic RAM (DRAM), a synchronous DRAM (SDRAM), a double date rate-SDRAM (DDR-SDRAM), and the like.

The driving controller 400 may be used to control the steering and acceleration/deceleration of a vehicle in response to a control signal from the processor 200, and may include a steering control module, an engine control module, a brake control module, and a transmission control module.

The steering control module includes a hydraulic power steering (HPS) system that controls steering by using hydraulic pressure generated by a hydraulic pump, and a motor driven power steering system (hereinafter referred to as ‘MDPS’) that controls steering by using the output torque of an electric motor.

The engine control module controls the acceleration of the vehicle, as an actuator that controls the engine of a vehicle. The engine control module may be implemented with an engine management system (EMS). The engine control module controls the driving torque of an engine depending on accelerator pedal location information output from an accelerator pedal location sensor. The engine control module controls the output of an engine to follow the driving speed of the vehicle requested by the processor 200 during autonomous driving or driving according to a driving assistance device.

The brake control module may be implemented with an electronic stability control (ESC), as an actuator that controls the deceleration of the vehicle. The brake control module controls the brake pressure for the purpose of following the target speed requested by the processor 200. That is, the brake control module controls the deceleration of the vehicle.

The transmission control module may be implemented with a shift-by-wire actuator for controlling the transmission of the vehicle. The shift controller controls the transmission of the vehicle depending on a gear location and a gear state range.

The communication device 500 may communicate with a user terminal, another vehicle, or an external server, and may receive weather information or vehicle information of surrounding vehicles.

The communication device 500 may support the short range communication by using at least one of Bluetooth, radio frequency identification (RFID), infrared data association (IrDA), ultra wideband (UWB), ZigBee, near field communication (NFC), Wireless-Fidelity (Wi-Fi), Wi-Fi Direct, or wireless universal serial bus (Wireless USB) technologies.

The communication device 500 may include a global positioning system (GPS) module or a differential global positioning system (DGPS) module to obtain location information.

Moreover, the communication device 500 may include a V2X communication module. The V2X communication module may include an RF circuit for a wireless communication protocol with a server (vehicle to infra (V2I)), another vehicle (vehicle to vehicle (V2V)), or a pedestrian (vehicle to pedestrian (V2P)). The communication device 500 may receive sensing data obtained by a sensor device of another vehicle through a V2X communication module and may provide the processor 200 with the sensing data.

The notification device 600 may notify an occupant of a vehicle tracking situation and vehicle avoidance situation by the processor 200. The notification device 600 may include a display, a speaker, or the like.

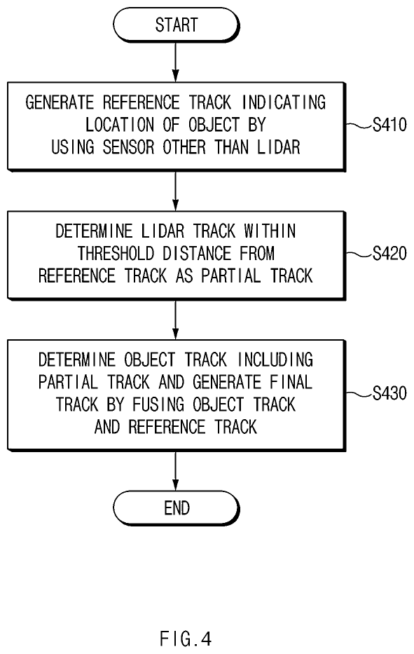

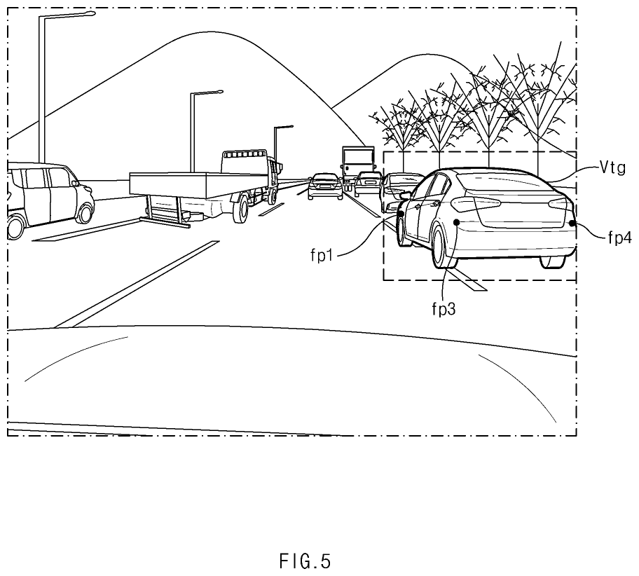

FIG. 4 shows an example of an object tracking method, according to an example of the present disclosure. A procedure shown in FIG. 4 may be performed by the processor shown in FIGS. 1 and 3. The object tracking method according to an example of the present disclosure will be described with reference to FIGS. 1 and 4. Hereinafter, an example described later will be described focusing on a target vehicle detected in an image obtained by the camera shown in FIG. 5.

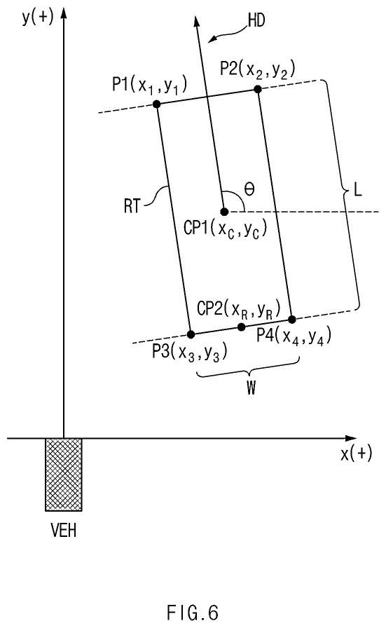

In S410, the processor 200 may generate a reference track based on image data obtained by the camera 110. The reference track is described based on FIGS. 5 and 6 as follows.

FIG. 5 shows an example of an image expressed by image data obtained by a camera. FIG. 6 shows an example of a reference track generated by a processor.

Referring to FIG. 5, the processor 200 may detect arbitrary feature points fp1, fp3, and fp4 from image data. The first feature point fp1 may indicate a left end of a front side of a target vehicle Vtg; the third feature point fp3 may indicate a left end of a rear side of the target vehicle Vtg; and, the fourth feature point ft4 may be the right end of the rear side of the target vehicle Vtg.

The feature points fp1, fp3, and fp4 in image data may include image coordinate information. The processor 200 may convert image coordinates of the feature points fp1, fp3, and fp4 into world coordinates (e.g., x, y, z-axes) in a world coordinate system. The world coordinate system may be used to express arbitrary point locations in actual physical space. In an example of the present disclosure, an origin in the world coordinate system may be a point where a straight line perpendicular to a horizontal plane while passing through the center of a front bumper of a vehicle meets the horizontal plane. In the world coordinate system, an x-axis may be a transverse direction of a traveling direction of the vehicle, a y-axis may be the traveling direction of the vehicle, and a z-axis is perpendicular to both x-axis and y-axis. The processor 200 may convert image coordinates into world coordinates by using a homography matrix.

Moreover, as shown in FIG. 6, the processor 200 may display points P1, P3, and P4 corresponding to the feature points fp1, fp3, and fp4 on a x-y plane of the world coordinate system. In FIG. 6, the first point P1 may be obtained by expressing the first feature point fp1 in the world coordinates; the third point P3 may be obtained by expressing the third feature point fp3 in the world coordinates; and, the fourth point P4 may be obtained by expressing the fourth feature point fp4 in the world coordinates.

Furthermore, the processor 200 may determine a second point P2 corresponding to a right end of a front side of the vehicle based on the feature points fp1, fp3, and fp4.

Alternatively or Additionally or alternatively, the processor 200 may calculate the first to fourth points P1, P2, P3, and P4 based on a center point CP1 of the target vehicle Vtg, a rear bumper center point CP2 of the target vehicle Vtg, a width W of the target vehicle Vtg, a length L of the target vehicle Vtg, and a heading angle θ of the target vehicle Vtg. In this specification, the heading angle θ of the target vehicle Vtg may mean an internal angle between a traveling direction HD of the target vehicle Vtg and (+) direction of the x-axis.

The x-coordinate and y-coordinate of each of the first to fourth points P1, P2, P3, and P4 may be calculated, as a function of trigonometry, for example, based on Equation 1 below.

$${x}_{1} = {x}_{C} + 0.5 * L * cos ( θ ) - 0.5 * W * sin ( θ ) \qquad [ Equation 1 ]$$

$${y}_{1} = {y}_{C} + 0.5 * L * sin ( θ ) + 0.5 * W * cos ( θ )$$

$${x}_{2} = {x}_{C} + 0.5 * L * cos ( θ ) + 0.5 * W * sin ( θ )$$

$${y}_{2} = {y}_{C} + 0.5 * L * sin ( θ ) - 0.5 * W * cos ( θ )$$

$${x}_{3} = {x}_{C} - 0.5 * L * cos ( θ ) - 0.5 * W * sin ( θ )$$

$${y}_{3} = {y}_{C} - 0.5 * L * sin ( θ ) + 0.5 * W * cos ( θ )$$

$${x}_{4} = {x}_{C} - 0.5 * L * cos ( θ ) + 0.5 * W * sin ( θ )$$

$${y}_{4} = {y}_{C} - 0.5 * L * sin ( θ ) - 0.5 * W * cos ( θ )$$

To this end, the processor 200 may receive, from the camera 110 or another processor, information about the center point CP1 of the target vehicle Vtg, the rear bumper center point CP2 of the target vehicle Vtg, the width W of the target vehicle Vtg, the length L of the target vehicle Vtg, and the heading angle θ of the target vehicle Vtg.

Alternatively or Additionally or alternatively, as in Equation 2 below, the processor 200 may calculate the center point CP1 of the target vehicle Vtg based on the rear bumper center point CP2 of the target vehicle Vtg, the length L of the target vehicle Vtg, and the heading angle θ of the target vehicle Vtg.

$${x}_{C} = {x}_{R} + 0.5 * L * cos ( θ ) \qquad [ Equation 2 ]$$

$${y}_{C} = {y}_{R} + 0.5 * L * sin ( θ )$$

In S420, the processor 200 may determine a LIDAR track as a partial track based on a location relationship between the LIDAR track and the reference track RT.

The LIDAR track may be generated based on information obtained by the LIDAR 120 and may be determined based on the cluster state of point clouds.

The processor 200 may determine the LIDAR track within a threshold distance from the reference track RT as a partial track. A method of determining a partial track will be described in detail as follows.

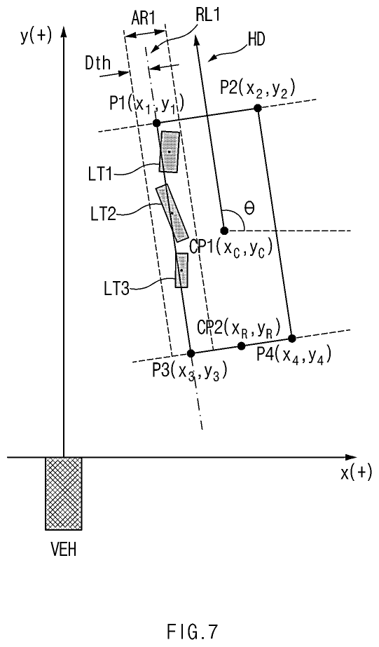

FIGS. 7 to 10 show examples of a method of determining a partial track.

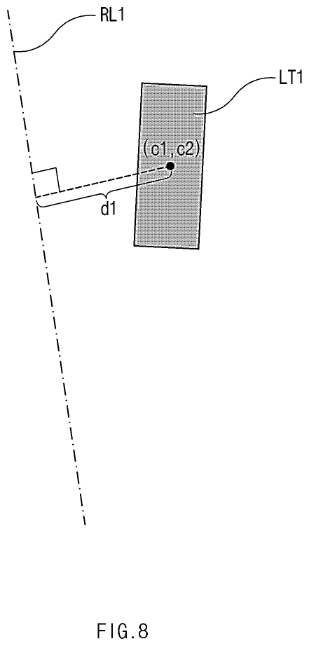

FIGS. 7 and 8 show examples of a method of determining whether a LIDAR track is included in a first area.

Referring to FIGS. 7 and 8, a first area AR1 may be an area located within a threshold distance Dth from an arbitrary line segment in the reference track RT.

The processor 200 may determine whether the shortest distance is within the threshold distance Dth, by comparing the shortest distance between a first reference line RL1 and a center point of each of the LIDAR tracks LT1, LT2, and LT3.

The first reference line RL1 may include a line segment indicating a side surface of the target vehicle Vtg in the reference track RT. For example, the first reference line RL1 may include a line segment indicating a side surface, which is closer to the host vehicle VEH, chosen from among both side surfaces of the target vehicle Vtg. The host vehicle VEH may refer to a vehicle that performs object estimation and vehicle control by using a vehicle control apparatus CM according to an example of the present disclosure.

As shown in FIG. 7, the first reference line RL1 may be a straight line for connecting the first point P1 and the third point P3. The first reference line RL1 may be a straight line expressed as “A₁x+B₁y+C₁=0”.

As shown in FIG. 8, when coordinates of the center point of the first LIDAR track LT1 are (x0, y0), a distance d1 between the first reference line RL1 and the center point of the first LIDAR track LT1 may be calculated based on Equation 3 below.

$$d 1 = \frac{\vert {A}_{1} x 0 + {B}_{1} y 0 + {C}_{1} \vert}{\sqrt{{A}_{1}^{2} + {B}_{1}^{2}}} \qquad [ Equation 3 ]$$

If the distance d1 is smaller than or equal to the threshold distance Dth, the processor 200 may determine that the first LIDAR track LT1 is included in the first area AR1. Similarly, if the shortest distance between the center point of the second LIDAR track LT2 and the first reference line RL1 is smaller than or equal to the threshold distance Dth, the processor 200 may determine that the second LIDAR track LT2 is included in the first area AR1. Moreover, if the shortest distance between the center point of the third LIDAR track LT3 and the first reference line RL1 is smaller than or equal to the threshold distance Dth, the processor 200 may determine that the third LIDAR track LT3 is included in the first area AR1.

According to an example, the threshold distance Dth may vary depending on driving situations.

In a situation where it is predicted that the reception rate of the LIDAR 120 is reduced, the processor 200 may set the threshold distance Dth to be greater.

For example, lower the reflectance of the target vehicle Vth is, the processor 200 may set the threshold distance Dth to be greater.

Furthermore, as a weather state, in an area where the host vehicle VEH is driving, deteriorates or worsens, the processor 200 may set the threshold distance Dth to be greater. The case that the weather state is severe may mean that it is raining or snowing (e.g., more than a threshold amount, for example, 2-3 inches of rain or snow) or that visibility has a specific level or less (e.g., nautical miles) because the weather is cloudy. To determine the weather state, the processor 200 may receive weather information through the communication device 500.

The processor 200 may determine whether the LIDAR tracks LT1, LT2, and LT3 included in the first area AR1 are included in a second area.

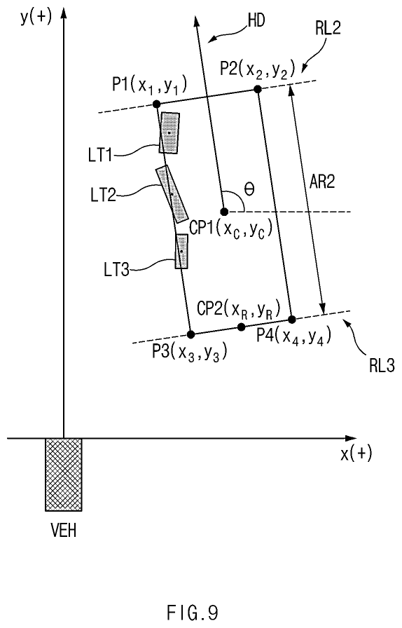

FIG. 9 shows an example of a method of determining whether a LIDAR track belongs to a second area.

Referring to FIG. 9, the second area AR2 may be an area located between a straight line connecting a front side of a vehicle and a straight line connecting a rear side of the vehicle.

A second reference line RL2 connecting the front side of the vehicle may be expressed as “A₂x+B₂y+C₂=0”. Additionally or alternatively, a third reference line RL3 connecting the rear side of the vehicle may be expressed as “A₃x+B₃y+C₃=0”.

The processor 200 may determine whether the center point of the first LIDAR track LT1 is located between a second reference line RL2 and a third reference line RL3. The processor 200 may determine a center point location of the first LIDAR track LT1, by substituting coordinates (x0, y0) of the center point of the first LIDAR track LT1 into x-coordinate and y-coordinate of each of the second reference line RL2 and the third reference line RL3.

If the result of substituting (x0, y0) into x-coordinate and y-coordinate of the second reference line RL2 is greater than 0, the processor 200 may determine that the center point of the first LIDAR track LT1 is located below the second reference line RL2.

Moreover, if the result of substituting (x0, y0) into x-coordinate and y-coordinate of the third reference line RL3 is smaller than 0, the processor 200 may determine that the center point of the first LIDAR track LT1 is located above the third reference line RL3.

As a result, if both Condition 1 and Condition 2 expressed in Equation 4 below are satisfied, the processor 200 may determine that the center point (x0, y0) of the first LIDAR track LT1 is located in the second area AR2, which is located between the second reference line RL2 and the third reference line RL3.

$$\begin{matrix}[ Equation 4 ] & \\ {A}_{2} x 0 + {B}_{2} y 0 + {C}_{2} > 0 & Condition 1\end{matrix}$$

$${A}_{3} x 0 + {B}_{3} y 0 + {C}_{3} < 0 \qquad Condition 2$$

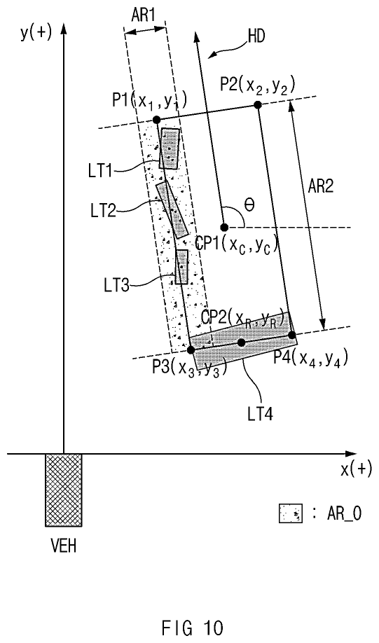

FIG. 10 shows an example of LIDAR tracks located within a reference track and a threshold distance.

Referring to FIG. 10, the processor 200 may determine, as a partial track, the LIDAR tracks LT1, LT2, and LT3 whose center points are located in an area AR_O where the first area AR1 overlaps the second area AR2.

In S430, the processor 200 may determine an object track including a partial track and may generate a final track indicating the location of the object by fusing the object track and the reference track RT.

The object track may include an object candidate track in addition or alternative to the partial track.

The object candidate track may be determined based on an overlapping level between the object candidate track and the reference track RT, and a matching level of directions of the object candidate track and the reference track RT. For example, as shown in FIG. 10, a fourth LIDAR track LT4 may overlap the reference track RT by a specific level or more. The location of the fourth LIDAR track LT4 may be determined to be within a rear bumper area of the target vehicle, and the shape of the fourth LIDAR track LT4 may be determined as a rear bumper of the target vehicle. Accordingly, the processor 200 may determine that the fourth LIDAR track LT4 is located within the rear bumper area of the target vehicle. In other words, even though the center point of the fourth LIDAR track LT4 is not located within the overlapping area AR_O between the first area AR1 and the second area AR2, the fourth LIDAR track LT4 may be determined as a part of the target vehicle Vtg.

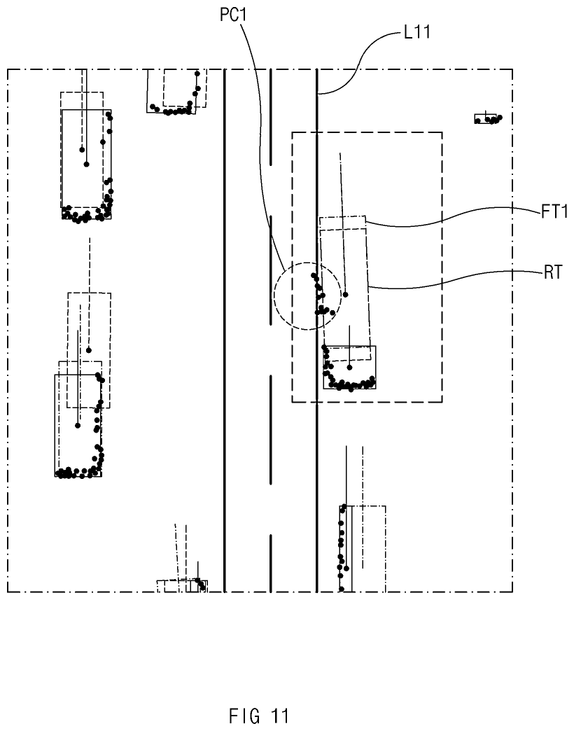

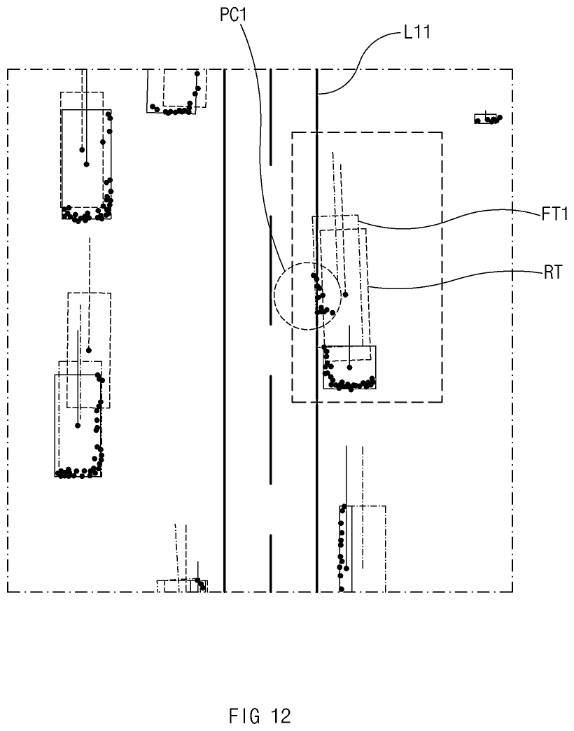

According to an example of the present disclosure, the location of an object may be accurately determined because the object track is determined to include a partial track in addition or alternative to the object candidate track. The final track generated based on an example of the present disclosure and the final track generated based on the comparative example will be described with reference to FIGS. 11 and 12 as follows.

FIG. 11 shows an example of a final track according to a comparative example. FIG. 12 shows an example of a final track, according to an example of the present disclosure. FIGS. 11 and 12 may be a final track for the target vehicle shown in FIG. 5.

As shown in FIG. 5, if the target vehicle Vtg has low reflectivity (e.g., lower than a threshold reflectivity) assuming that the target vehicle Vtg is in black, a set of points (e.g., a point cloud) obtained by the LIDAR 120 may be lost. In particular, there may be a lot of loss in point clouds in an area, in which an angle of incidence of laser transmitted by the LIDAR 120, such as a side surface of the front vehicle is greater.

For example, as shown in FIG. 11, according to the comparative example, point clouds corresponding to a left side surface of the target vehicle Vtg are lost, and thus the LIDAR tracks LT1, LT2, and LT3 may be obtained in a fragmented form as shown in FIG. 7. The fragmented LIDAR tracks LT1, LT2, and LT3 shown in FIG. 7 are inconsistent in shape, direction, and size, and thus the LIDAR tracks LT1, LT2, and LT3 may not be identified as object candidate tracks constituting the target vehicle Vtg. Accordingly, according to the comparative example, fragmented point clouds (e.g., PC1 of FIGS. 11 and 12) of a side area of the target vehicle Vtg may not be used in a process of recognizing the target vehicle Vtg.

Therefore, the location of the target vehicle Vtg may be somewhat inaccurate because a first final track FT1 shown in FIG. 11 is formed based on point clouds excluding the fragmented point clouds PC1. For example, the target vehicle Vtg shown in FIG. 5 is in a lane violation state. However, it is determined that the first final track F1 according to the comparative example shown in FIG. 11 is in a state where a lane L11 is not violated. Accordingly, a vehicle may not be smoothly controlled because the location and driving state of the target vehicle Vtg are inaccurately determined.

On the other hand, according to an example of the present disclosure, the fragmented LIDAR tracks LT1, LT2, and LT3 may be included in an object track by using the method shown in FIGS. 7 to 10. In other words, according to an example of the present disclosure, the fragmented point clouds PC1 shown in FIG. 12 may be reflected to a process of determining the second final track ft2. Accordingly, it may be determined that the second final track ft2 shown in FIG. 12 invades the lane L11, by accurately determining the state of the target vehicle Vtg. Moreover, the processor 200 may allow the driving controller 400 to drive a vehicle safely based on the second final track ft2.

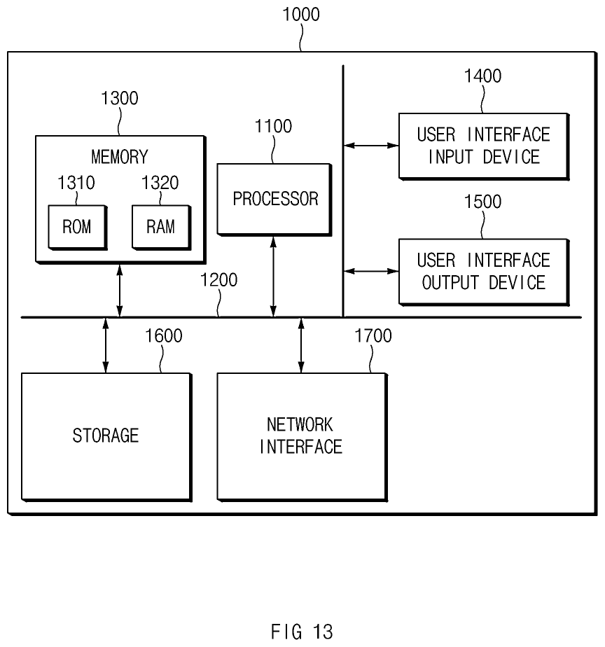

FIG. 13 illustrates a computing system according to an example of the present disclosure.

Referring to FIG. 13, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) and a random access memory (RAM).

Accordingly, the operations of the method or algorithm described in connection with the examples disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively or Additionally or alternatively, the storage medium may be integrated with the processor 1100. The processor and storage medium may be implemented with an application specific integrated circuit (ASIC). The ASIC may be provided in a user terminal. Alternatively or Additionally or alternatively, the processor and storage medium may be implemented with separate components in the user terminal.

The above description is merely an example of the technical idea of the present disclosure, and various modifications and modifications may be made by one skilled in the art without departing from the essential characteristic of the present disclosure.

The present disclosure has been made to solve the above-mentioned problems occurring in the prior art while advantages achieved by the prior art are maintained intact.

An example of the present disclosure provides an object tracking apparatus capable of fully using information obtained by a LIDAR, and a vehicle control apparatus using the same.

Moreover, an example of the present disclosure provides an object tracking apparatus capable of tracking a location of an object accurately in a sensor fusion process, and a vehicle control apparatus using the same.

Furthermore, an example of the present disclosure provides an object tracking apparatus capable of smoothly controlling a vehicle based on object tracking by using accurate sensor fusion, and a vehicle control apparatus using the same.

Also, an example of the present disclosure provides an object tracking apparatus capable of accurately determining an object location even if a point cloud obtained the LIDAR is missing due to a distance to the object and the external reflectance of the object, and a vehicle control apparatus using the same.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, an object tracking apparatus may include a camera that obtains image data, a light imaging detection and ranging (LIDAR) that obtains a point cloud, and a processor that detects an object outside a host vehicle. The processor may determine a LIDAR track as a partial track, if the LIDAR track generated based on information obtained by the LIDAR is within a predetermined threshold distance from a reference track generated based on the image data, may determine an object track including the partial track, and may generate a final track indicating a location of the object, by fusing the object track and the reference track.

According to an example, the reference track may be obtained by expressing the object detected from the image data in a top-view in a world coordinate system.

According to an example, the LIDAR track may be expressed in a top-view in a world coordinate system based on a cluster state of the point cloud.

According to an example, the processor may determine a first reference line indicating a side surface of a target vehicle in the reference track and may determine whether the shortest distance between the first reference line and a center point of the LIDAR track is within the threshold distance.

According to an example, the processor may determine, as the first reference line, a line segment indicating a side surface, which is close to the host vehicle, from among both side surfaces of the target vehicle.

According to an example, the processor may determine, as the first reference line, a straight line connecting one end of a front bumper of the target vehicle and one end of a rear bumper of the target vehicle and may compare the shortest distance between the center point of the LIDAR track and the first reference line with the threshold distance.

According to an example, the processor may include the LIDAR track in the object track if the center point of the LIDAR track is located between a second reference line indicating a front side of the target vehicle and a third reference line indicating a rear side of the target vehicle.

According to an example, the processor may set the threshold distance to be great, as reflectance of the target vehicle is low.

According to an example, the processor may set the threshold distance to be great, as a weather state in an area where the host vehicle is driving is severe.

According to an example of the present disclosure, a vehicle control apparatus may include a camera that obtains image data, a LIDAR that obtains a point cloud, a processor that detects an object outside a vehicle, and a driving controller that drives the vehicle under control of the processor. The processor may determine a LIDAR track as a partial track, if the LIDAR track generated based on information obtained by the LIDAR is within a predetermined threshold distance from a reference track generated based on the image data, may determine an object track including the partial track, and generate a final track indicating a location of the object, by fusing the object track and the reference track.

According to an example of the present disclosure, an object tracking method may include generating a reference track indicating a location of an object detected by using a sensor other than a LIDAR, determining a LIDAR track as a partial track, if the LIDAR track generated based on information obtained by the LIDAR is within a threshold distance from the reference track, and determining an object track including the partial track and generating a final track indicating the location of the object, by fusing the object track and the reference track.

According to an example, the generating of the reference track may include expressing the object detected from an image data in a top-view in a world coordinate system.

According to an example, the determining of the LIDAR track as the partial track may include expressing the LIDAR track, which is determined based on a cluster state of a point cloud obtained by the LIDAR, in a top-view in a world coordinate system.

According to an example, the determining of the LIDAR track as the partial track may include determining a first reference line indicating a side surface of a target vehicle in the reference track, and determining whether the shortest distance between the first reference line and a center point of the LIDAR track is within the threshold distance.

According to an example, the determining of the first reference line may include determining, as the first reference line, a line segment indicating a side surface, which is close to the host vehicle, from among both side surfaces of the target vehicle.

According to an example, the determining of the LIDAR track as the partial track may include comparing the shortest distance between the center point of the LIDAR track and the first reference line with the threshold distance.

According to an example, the determining of the LIDAR track as the partial track may include obtaining a second reference line indicating a front side of the target vehicle based on a fact that the shortest distance between the center point of the LIDAR track and the first reference line is within the threshold distance, obtaining a third reference line indicating a rear side of the target vehicle, and including the LIDAR track in the object track based on a fact that the center point of the LIDAR track is located between the second reference line and the third reference line.

According to an example, the object tracking method may further include setting the threshold distance to be great, as reflectance of the target vehicle is low.

According to an example, the object tracking method may further include setting the threshold distance to be great, as a weather state in an area where a host vehicle is driving is severe.

According to an example of the present disclosure, a method of controlling a vehicle may include generating a reference track indicating a location of an object outside a vehicle detected by using a sensor, determining a LIDAR track as a partial track, if the LIDAR track generated based on information obtained by a LIDAR is within a threshold distance from the reference track, determining an object track including the partial track and generating a final track indicating the location of the object, by fusing the object track and the reference track, and controlling driving of the vehicle based on the final track.

Accordingly, examples of the present disclosure are intended not to limit but to explain the technical idea of the present disclosure, and the scope and spirit of the present disclosure is not limited by the above examples. The scope of protection of the present disclosure should be construed by the attached claims, and all equivalents thereof should be construed as being included within the scope of the present disclosure.

According to an example of the present disclosure, even if a LIDAR point cloud is partially missing, LIDAR information corresponding to an object may be fully used.

Moreover, according to an example of the present disclosure, object location tracking performance may be improved because the object is capable of being determining by reflecting LIDAR information that may be missing due to a lost point cloud.

Furthermore, according to an example of the present disclosure, vehicle control may be smoothly performed based on object tracking using accurate sensor fusion.

Also, according to an example of the present disclosure, even if a point cloud obtained by the LIDAR is missing due to a distance to the object and the external reflectance of the object, the location of the object may be accurately determined based on the fragmented point cloud.

Besides, a variety of effects directly or indirectly understood through the specification may be provided.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus comprising:
a camera configured to obtain image data;
a sensor configured to obtain a set of points; and
a processor,
wherein the processor is configured to:
detect an object outside a vehicle;
determine a track as a partial track, based on a determination that the track is within a threshold distance from a reference track generated based on the image data, wherein the track is generated based on information obtained by the sensor;
determine an object track including the partial track; and
generate, by fusing the object track and the reference track, a final track indicating a location of the object; and
output a signal indicating the final track.

2. The apparatus of claim 1, wherein the reference track is obtained by expressing the object in a top-view in a coordinate system, wherein the object is detected from the image data.

3. The apparatus of claim 1, wherein the track is expressed in a top-view in a coordinate system based on a cluster state of the set of points.

4. The apparatus of claim 1, wherein the processor is configured to:
determine a first reference line indicating a side surface of the object, wherein the object is in the reference track; and
determine whether the shortest distance between the first reference line and a center point of the track is within the threshold distance.

5. The apparatus of claim 4, wherein the processor is configured to:
determine, as the first reference line, a line segment indicating a side surface, which is closer to the vehicle, chosen from among a plurality of side surfaces of the object.

6. The apparatus of claim 4, wherein the processor is configured to:
determine, as the first reference line, a straight line connecting one end of a front bumper of the object and one end of a rear bumper of the object; and
compare the shortest distance between the center point of the track and the first reference line with the threshold distance.

7. The apparatus of claim 4, wherein the processor is configured to:
include the track in the object track based on a determination that the center point of the track is located between a second reference line indicating a front side of the object and a third reference line indicating a rear side of the object.

8. The apparatus of claim 1, wherein the processor is configured to:
increase the threshold distance as reflectance of the object decreases.

9. The apparatus of claim 1, wherein the processor is configured to:
increase the threshold distance as a weather state in an area comprising the vehicle, deteriorates.

10. The apparatus of claim 1,
wherein the processor is configured to control the vehicle based on the signal indicating the final track.

11. A method comprising:
generating a reference track indicating a location of an object detected by using a sensor other than a light imaging detection and ranging (LIDAR) sensor;
determining a track as a partial track, based on a determination that the track is within a threshold distance from the reference track, wherein the track is generated based on information obtained by the LIDAR sensor; and
determining an object track including the partial track;
generating, by fusing the object track and the reference track, a final track indicating the location of the object; and
outputting a signal indicating the final track.

12. The method of claim 11, wherein the generating the reference track comprises expressing the object in a top-view in a coordinate system, wherein the object is detected from image data.

13. The method of claim 11, wherein the determining the track as the partial track comprises expressing the track, which is determined based on a cluster state of a set of points obtained by the LIDAR sensor, in a top-view in a coordinate system.

14. The method of claim 11, wherein the determining the track as the partial track comprises:
determining a first reference line indicating a side surface of the object, wherein the object is in the reference track; and
determining whether the shortest distance between the first reference line and a center point of the track is within the threshold distance.

15. The method of claim 14, wherein the determining of the first reference line comprises determining, as the first reference line, a line segment indicating a side surface, which is closer to a vehicle, chosen from among a plurality of side surfaces of the object.

16. The method of claim 15, wherein the determining of the track as the partial track comprises comparing the shortest distance between the center point of the track and the first reference line with the threshold distance.

17. The method of claim 14, wherein the determining of the track as the partial track comprises:
obtaining a second reference line indicating a front side of the object based on the shortest distance between the center point of the track and the first reference line being within the threshold distance;
obtaining a third reference line indicating a rear side of the object; and
including the track in the object track based on the center point of the track being located between the second reference line and the third reference line.

18. The method of claim 11, further comprising:
increasing the threshold distance as reflectance of the object decreases.

19. The method of claim 11, further comprising:
increasing the threshold distance as a weather state, in an area comprising a vehicle, deteriorates.

20. The method of claim 11, further comprising:
controlling the vehicle based on the signal indicating the final track, wherein the location of the object is outside the vehicle.
